(19) United States
(12) Patent Application Publication
(10) Pub. No.: US 2012/0266481 A1
(43) Pub. Date: Oct. 25, 2012

(54) Special Free Moisture Removal System

(76) Inventors: Tim Heffernan, Indianapolis, IN (US); Bruce Rea, CONNERSVILLE, IN (US)

(21) Appl. No.: 13/450,103

(22) Filed: Apr. 18, 2012

Related U.S. Application Data
(63) Continuation of application No. 61/476,945, filed on Apr. 19, 2011.

(51) Int. Cl. F26B 25/06; F26B 17/30

(52) U.S. Cl. 34/58; 34/218

(57) ABSTRACT

A non-thermal dewatering and drying system to remove, separate and segregate free moisture from an essentially granular form of organic and non-organic solid material mixed with free moisture and air. The energy efficient separation and removal of the free moisture is by the system that creates differential pressures in adjacent moving flows. Such pressure differentials result in the induced flash vaporization of free moisture from granular materials, simultaneously with the separation and segregation of water vapor into a moving flow of adjacent air. The system has a novel design that allows retains laminar/plug flow characteristics. The differential is created by increasing the velocity of the process air as it is introduced into the material transport piping of the system. This combining the material, free moisture and higher velocity air allows for rapid mechanical removal, separation and segregation of free water within the transport pipe.

### CROSS-REFERENCE TO RELATED APPLICATIONS

This application claims the benefit of Provisional Patent Application Ser. No. 61/476,945 filed Apr. 19, 2011 by Tim Heffernan and Bruce Rea and entitled “A Special Free Moisture Removal System”.

### FEDERALLY SPONSORED RESEARCH

Various Department of Energy [DOE] and Environmental Protection Agency [EPA] grants under consideration but not yet approved.

### FIELD OF INVENTION

This invention relates to a special system to remove free moisture from essentially granular materials. The system and related technology allow for the energy efficient separation and removal of free moisture from granular materials including both organic and inorganic materials. The system creates differential pressures in adjacent moving flows. Such pressure differentials result in the induced flash vaporization of free moisture from granular materials, simultaneously with the separation and segregation of water vapor into a moving flow of adjacent air, supported by a novel design that allows for and retains laminar/plug flow characteristics.

The system is sometimes called the Enviro-Dry Tornado Drying System™ or Eco Flash™. The Non-Thermal Drying System for dewatered waste solids is a revolutionary advance in the drying of granular materials and providing dramatic energy savings and a significantly smaller carbon footprint compared to other thermal drying technologies. The special system principally removes free moisture from an essentially granular material and is comprised of readily available components and parts configured in an unique combination. The applications anticipate a plethora of materials and applications and adapts well to existing operations as well as entirely new installations.

### SEQUENCE LISTING OR PROGRAM

None.

### BACKGROUND—FIELD OF INVENTION AND PRIOR ART

A. Problem Solved:

As far as known, there are no special systems without the use of significant heat and thermal assistance to remove free moisture from an essentially granular material or the like. It is believed that this product is unique in its design and technologies.

B. Prior Art:

Concerning the non-thermal drying system, a novelty patent search was completed of the patent data bases of patents and patent applications. The search revealed a few examples of prior art that were examined.

A U.S. Pat. No. 2,921,646 issued to Poole in 1960 is entitled “Moisture Separator”. This taught an apparatus for separating moisture from a gaseous fluid stream, and particularly to an apparatus for separating very small articles of moisture from a gaseous fluid steam, such as light fog held in suspension in the gaseous fluid stream. This was a laboratory or small scale device. Nothing inherent shows this a good manner to separate out granular materials from a combined air, moisture and granular materials. A U.S. Pat. No. 3,360,908 issued to Baily in 1968 is entitled “Nested Vortex Separator”. This taught improvements in devices for effecting the separation of suspended material from gases or vapors by centrifugal or vortical action. The device is much more complex and does not appear to lend itself to solids removal in industry as the Heffernan system provides.

A U.S. Pat. No. 3,305,940 issued to Isler et al. in 1967 is entitled “Heat Exchange Between Granular Material and Gas”. This taught a process for heat exchange between a finely granular material and a gas stream, more particularly for preheating, calcining and burning crude cement powder by waste kiln gases. The process does not remove the solids in the same manner as the system shown within this specification. A U.S. Pat. No. 3,802,167 issued to Turman in 1974 is entitled “Particle Sampling Apparatus”. It showed and discussed an apparatus, for collecting particles from a gaseous medium, adapted for use in sampling particulate in the atmosphere, such as from various portions of an atmospheric flight corridor through which is flown an aircraft on which, and external of which, the adapted apparatus is mounted. The device is used for sampling and not separating per se. It appears much more laminar flow intensive with no way to handle large amounts of solids.

A U.S. Pat. No. 4,180,391 issued to Perry, Jr. et al. in 1979 is entitled “Gas Particulate Separator With Scavenging Gas Separation Device”. This disclosed a separator is disclosed for removing from a gas stream suspended particulates such as liquid droplets and finely divided solids. A housing chamber encloses a tube that contains a gas swirl device for imparting a swirling motion to the gas stream entering the inlet of the tube. A separator conduit is axially aligned with the tube and has its upstream end coaxially located in the downstream end of the tube, defining an annular ejection port. Suspended particulates and scavenging gas are discharged into the chamber through the annular ejection port. The system shows no manner to handle large amounts of moisture laden solids but rather a gas promoted into a swirl and finely divided solids mixture. A U.S. Pat. No. 4,454,661 issued to Klein et al. in 1984 is entitled “Tornado Flow Separator for the thermal treatment of fine grain or granular material”. This taught a tornado flow separator for the thermal treatment of fine-grain or granular material with at least one gaseous medium, including a cylindrical reaction chamber having a surface, two ends and at least first, second and third treatment zones of substantially equal length through which the material passes after given dwelling time, tangential feeding means for the gaseous media being disposed in the surface of the reaction chamber in the treatment zones for setting the dwelling time of the material in the third treatment zone to be at least twice as long as the dwelling time in each of the first and second treatment zones, at least one inclined tangential material feed disposed in vicinity of one of the ends of the reaction chamber, at least one outlet for treatment material disposed in vicinity of the others of the ends of the reaction chamber, and an exhaust pipe for at least one of excess and spent gaseous media being axially extended into the reaction chamber from along side the material outlet and having a free opening in vicinity of the third treatment zone. This system requires heat to operate.

A U.S. Pat. No. 4,833,793 issued to White in 1989 is entitled “Anaerobic Pasteurizing Conditioning System”. This showed an anaerobic, pasteurizing conditioning system for treating matter such as whole and ground grain, minerals and other ingredients to increase the rate of their conversion and absorption during digestion and thus the nutritional value thereof. The system comprises a direct fired steam generator adapted for producing an effluent stream comprising steam and non-condensable gases, a vapor homogenizer for producing a substantially water-free treatment fluid from the effluent stream, and the treatment fluid containing insufficient oxygen for aerobic bacterial life. This system also requires heat to operate unlike the Heffernan system. A U.S. Pat. No. 5,498,273 issued to Mann in 1996 is entitled “Particle Separation”. This invention showed a vortex tube including an annular downstream scavenge duct is provided with a number of occluding members spaced circumferentially around the upstream entrance to the scavenge duct so as to restrict the entrance area of the duct. The occluding members are each generally triangular in section, are each attached to the wall of the vortex tube, and taper upstream from the entrance to the scavenge duct. The device is a basic vortex tube and does not address the input or output handling of the materials, moisture and air.

A U.S. Pat. No. 6,158,145 issued to Landon et al. in 2000 is entitled “Method for a High Turbulence Cyclonic Dryer”. This disclosed a method is provided in which particulate matter is dried in a high velocity cyclonic dryer having inner and/or outer ring deflectors. Contemplated initial air stream velocities are at least about 100 feet per second, with more preferred velocities at least 300 feet per second, and still more preferred embodiments at least 500 feet per second. In one aspect of preferred embodiments the combination of high velocity air flow and ring deflectors advantageously provides significant drying of the particulate matter using both relatively low temperatures and relatively short transit times. Contemplated temperatures of the air stream entering the dryer are between about 50.degree. F. and about 300.degree. F., with more preferred temperatures between about 60.degree. F. and about 150.degree. F., and still more preferred temperatures between about 70.degree. F. and about 120.degree. The Heffernan is a non-thermal dryer. A U.S. Pat. No. 6,364,940 issued to Prueter et al. in 2002 is entitled “Compact High Efficiency Gas/Liquid Separator Method and Apparatus”. This taught a method and apparatus for separating a wellhead fluid mixture containing oil and gas phases obtained from hydrocarbon production systems into its constituent parts employs a pressure vessel having an inlet for entry of the wellhead fluids mixture and an outlet for exit of a separated gas referred to as export gas. A primary centrifugal separator is provided in the pressure vessel for centrifugally separating a first portion of the oil from the wellhead fluids mixture to produce a wet gas containing some remaining oil. A second centrifugal separator is also provided in the vessel and performs a second centrifugal separation operation on the wet gas to remove substantially all of the remaining oil from the wet gas to produce the export gas which is conveyed out of the pressure vessel. The Heffernan device is not directed to the gas/oil industry, does not require heat, and has a single separator cyclone.

A U.S. Pat. No. 7,040,557 issued to Graham et al. in 2006 is entitled “System and Method for Pulverizing and Extracting Moisture”. This taught a venturi that receives incoming material through an inlet tube and subjects the material to pulverization. The material, as it undergoes pulverization, is further subject to moisture extraction and drying. An airflow generator, coupled to the venturi, generates a high speed airflow to pull the material through the venturi and into an inlet aperture in the airflow generator. The airflow generator directs the received pulverized material to an outlet where the material may be subsequently separated from the air. An acoustic emission sensor receives the resonant frequencies generated by material passing through the airflow generator. The resonant frequencies reflect a material flow rate that is adjusted to avoid an overload situation. An automatic balancer system couples to an axle rotating the airflow generator to provide balance, improve efficiency, and eliminate cavitation. The system is far more complex with significantly more parts than the system taught herein. Another U.S. Publication No. 20050217224 turned into a U.S. Pat. No. 7,380,348 issued to Seebach in 2008 is entitled “Material dewatering apparatus”. This invention provides a pneumatic dewatering apparatus for wet product. The apparatus comprises essentially a cyclone chamber connected to a centrifugal fan. Various vortex flow forming stations, each followed by a vortex shedding station, are mounted within the cyclone chamber. Tight centripetal vortices are formed and are then shed such that water is delivered out the cyclone chamber into a sump. The system is more complex and appears to use more energy than the Heffernan design.

A U.S. Publication No. 20080209753 turned into U.S. Pat. No. 8,056,255 and then issued to Smith et al. in 2011. This is entitled “Manure Removal and Drying System”. These both showed a manure removal and drying system is used in an agricultural setting. The system includes a static pressure control system for regulating an amount of static pressure in a high pressure area of the agricultural setting, a variable speed loading system for varying a speed of operation of the system based on an amount of manure being removed and dried in the agricultural setting, a moisture sensing control system for detecting moisture from the manure in order to activate or deactivate the system, a selective capacity control system for selectively scaling a distance the manure in the agricultural setting is moved, and a friction reduction system for reducing the buildup of friction within the system caused by the movement of belts. The system is more complex and has more components than the Heffernan system. A U.S. Publication No. 20090277039 was submitted by Rooksby in 2009 entitled “Pneumatic dewatering of particulate”. This disclosed and claimed a pneumatic dryer for removal of liquid from the surface of particulate. The dryer finds application in drying water from coal using air as a drying gas. A significant mechanism of the removal of liquid from particulate is the shearing of liquid without a phase change from the particulate surface. Heffernan is a compact footprint and may be used with a wide variety of moisture laden solids.

Lastly, another A U.S. Patent Application by Flaherty et al. was published as 20100223804 in 2010. This taught a device entitled “Air modulating non-thermal dryer”. Here is taught an air modulating non-thermal dryer (AMND) system that de-waters a wet feedstock stream with an ambient airstream, to produce a dried product stream. The system utilizes a drying chamber in the efficient production of a dried product, and includes an acoustic induced air motion liberation or “SONICATION™” of the moisture with a combination of drivers, labyrinth transmission lines, and air modulating devices. Initially, a 50% to 60% dry composite of biomass or bio-solids is pneumatically conveyed to the chamber through an in-line cutter and a swiveling load leveler with an atomizing nozzle for final shredding. The system can liberate up to 90% of the moisture content, using high volumes of process air, along with in-feed motive air to deliver wet feedstock material into the chamber. Expelled airborne moisture may be discharged to atmosphere, without further processing, or it may be recaptured for potable uses. This system takes a very large footprint and structural support system. The material handling is far more complex than that shown by Heffernan.

It appears that the special system to remove free moisture from an essentially granular material as an idea and technology provides novel, useful and non-obvious merits when compared to prior art. It is not anticipated in other specifications, drawings or claims. None of the prior art reveals or appears to be a substantial equivalent (i.e. to perform substantially the same function, in substantially the same way, to achieve substantially the same result) as the special system to remove free moisture from an essentially granular material which is demonstrated by invention of Tim Heffernan.

### SUMMARY OF THE INVENTION

This invention is a special system to remove free moisture from an essentially granular material. The system and technology allow for the energy efficient separation and removal of free moisture from granular materials including both organic and inorganic materials. The system creates differential pressures in adjacent moving flows. Such pressure differentials result in the induced vaporization of free moisture from granular materials and the simultaneous separation and segregation of such vapor into a moving flow of adjacent air, achieved through mechanical rather than thermal means. The system is adaptable to a plethora of granular materials that require the removal of free moisture. The various applications and some examples of use are shown and described below. One or more of the special systems to remove free moisture from an essentially granular material may be installed as new and original equipment option or an add-on system in various industries and situations that require dewatering of free moisture from granular materials.

The preferred embodiment of the special system to remove free moisture from an essentially granular material is comprised of various readily available components produced in in different configurations and made of various durable materials. More descriptions, illustrations and alternatives are discussed in the paragraphs below in the detailed description and operation sections. Simply stated, the special system is:
“A special drying system to remove free moisture from an essentially granular material, (the material consisting of an essentially granular form of solid material mixed with moisture and air) the removal system comprised of
   1. A Feed Hopper for the material;
   2. A means for conveying a material from the feed hopper into the drying system;
   3. A machine frame for aligning and stabilizing a set of components for the dryer;
   4. An enclosure over the machine frame;
   5. A means for conveying the material into the drying chamber;
   6. An air source that provides and introduces process air;
   7. A transfer means for conveying the process air from the air source into the drying system enclosure;
   8. A Means for conveying the process air from the transfer means to a mixing chamber all within the drying system enclosure;
   9. A mixing chamber;
   10. A means of increasing the velocity (speed) of the process air as it enters and introduces the process air into the material transport piping of the dryer system, said introduction of the process air combining with the material and resulting a combination of a free moisture, material, and the process air wherein the combination travels at a higher velocity;
   11. A material breaker mechanism;
   12. A transport pipe that conveys the combination of the material, the free moisture and the higher velocity air;
   13. A means for separating dried solids from moisture-laden air stream;
   14. A means for discharging dried solids from the system;
   15. A means for discharging moisture laden air and fine solids.”

The newly invented special non-thermal drying system to remove free moisture from an essentially granular material may be manufactured at low volumes by very simple means for initial applications. When a higher volume production is required, the simple configuration of the non-thermal drying system may be adapted and manufactured by efficient, quality controlled manufacturing processes.

### OBJECTS AND ADVANTAGES

There are several objects and advantages of the special system to remove free moisture from an essentially granular material. The technology allows for the energy efficient separation and removal of free moisture from granular materials including both organic and inorganic materials. The system creates differential pressures in adjacent moving flows. Such pressure differentials result in the induced flash vaporization of free moisture from granular materials, simultaneously with the separation and segregation of water vapor into a moving flow of adjacent air, supported by a novel design that allows for and retains laminar/plug flow characteristics.

There are currently no known dewatering of granular materials that are effective at providing the objects of this invention.

In the industries where the removal of free moisture from essentially granular materials few effective and efficient systems exist. This System for dewatered waste solids is a revolutionary advance in the drying of granular materials and providing dramatic energy savings and a significantly smaller carbon footprint compared to other thermal drying technologies.

The special system to remove free moisture from essentially granular materials allows for enhanced net energy produced through subsequent oxidation and allows for:
rapid mechanical removal of free moisture (water) within the transport pipe;
granular material segregation by mass within the transport pipe;
separation of dry solids and moist air via cyclone at the end of the system;
the creation of nearly laminar flow conditions via the air-driven system; and
extensive drying using multi-stage systems.

Finally, other advantages and additional features of the present special system to remove free moisture from an essentially granular material will be more apparent from the accompanying drawings and from the full description of the device. For one skilled in the art of dewatering and free moisture removal from granular materials, it is readily understood that the features, configurations and materials shown in the examples with this novel non-thermal drying system are readily adapted to other types of dewatering systems and devices.

### DESCRIPTION OF THE DRAWINGS

### Figures

The accompanying drawings, which are incorporated in and constitute a part of this specification, illustrate an embodiment of the special non-thermal drying system to remove free moisture from an essentially granular material. The system is a special non-thermal drying system. The drawings together with the summary description given above and a detailed description given below serve to explain the principles of the special dewatering system to remove free moisture. It is understood, however, that the special dewatering system to remove free moisture is not limited to only the precise arrangements and instrumentalities shown.

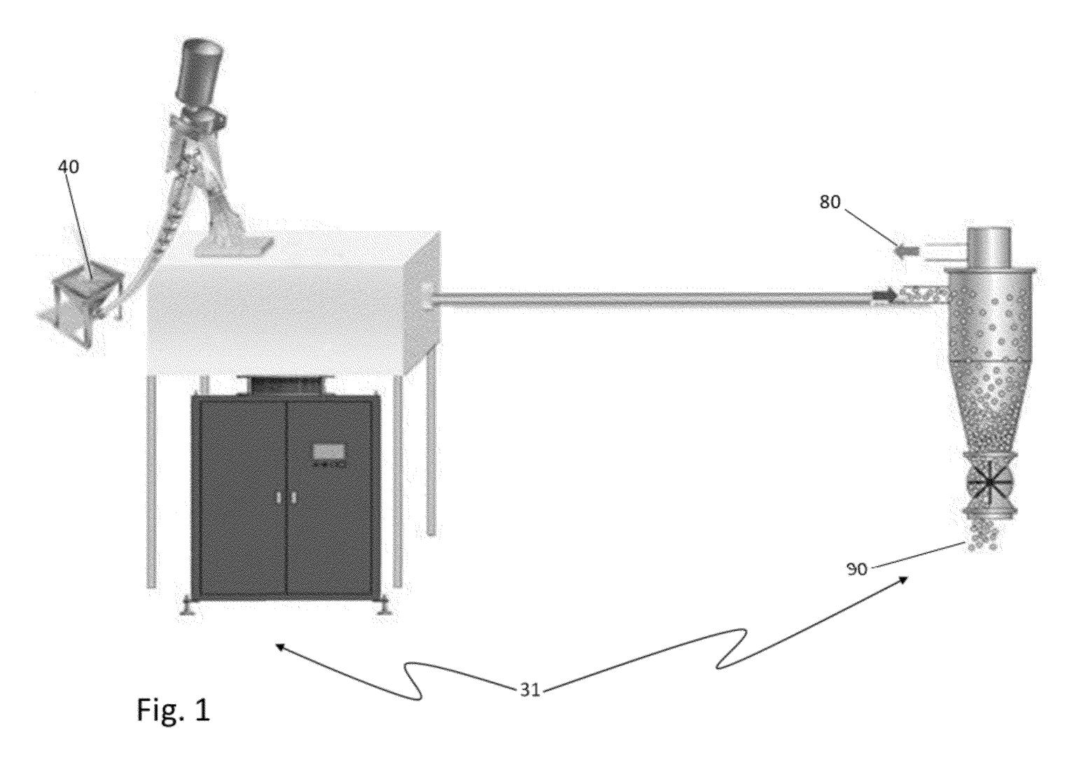

FIG. 1 is a sketch of the general embodiment of a special free moisture removal system.

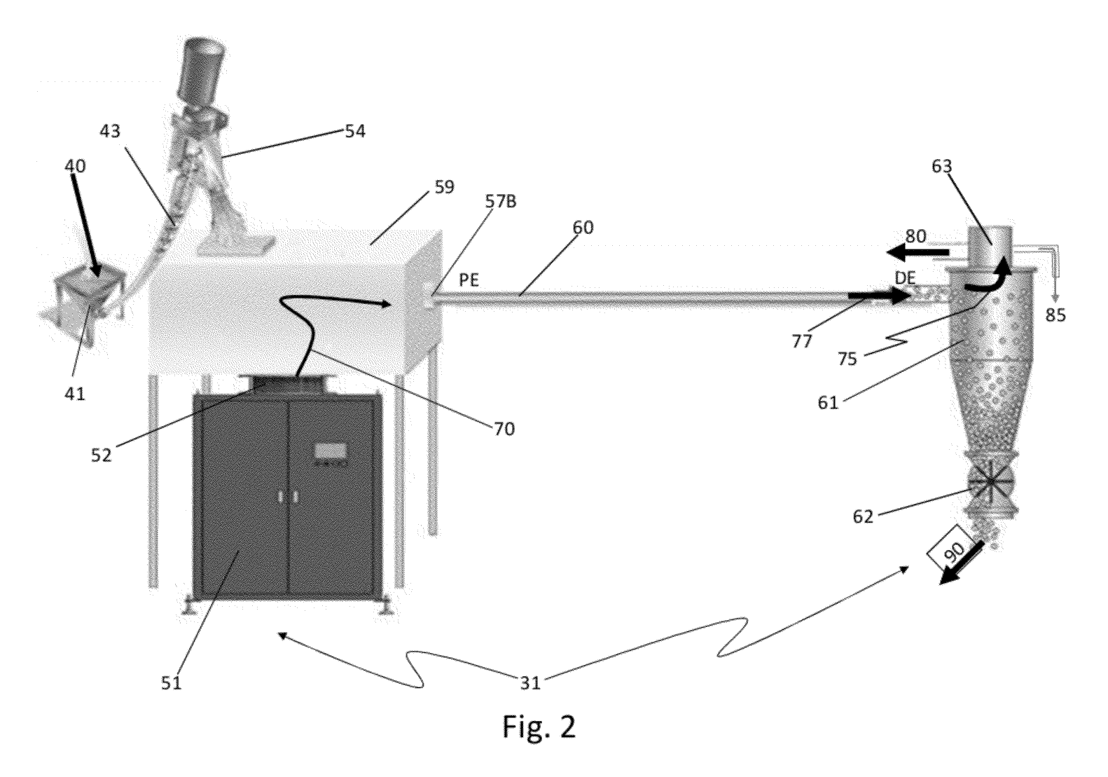

FIG. 2 is a sketch of the general embodiment of a special free moisture removal system with components and features identified an depicted.

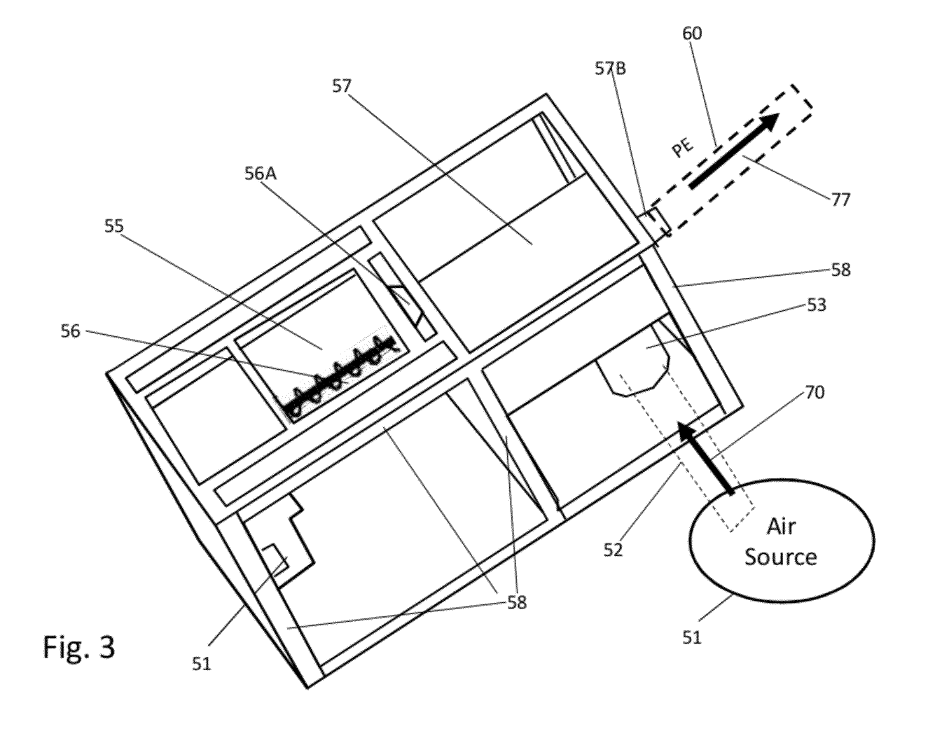

FIG. 3 is an isometric sketch of a general embodiment of a special free moisture removal system with the components and features shown from generally a top and side view.

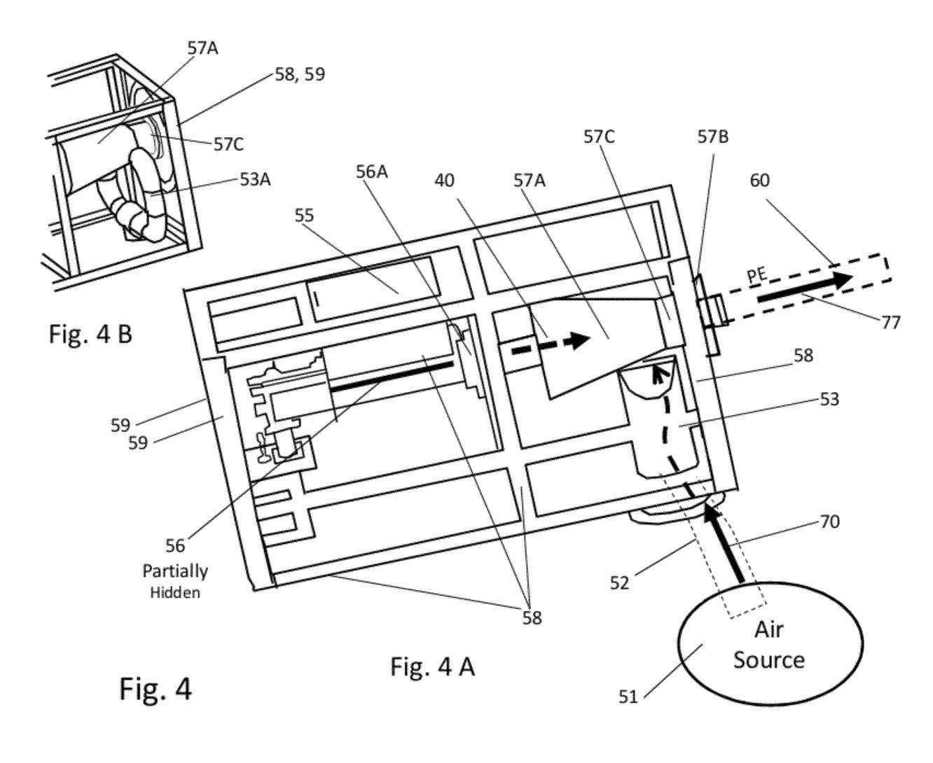

FIG. 4 is another isometric sketch of a general embodiment of a special free moisture removal system with the components and features shown.

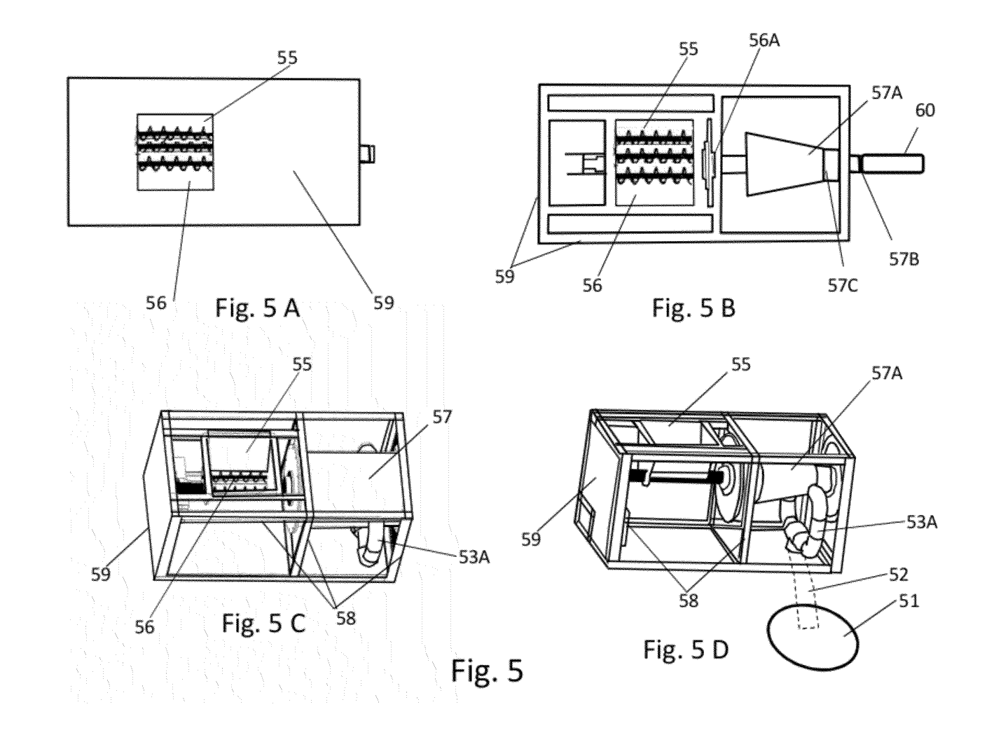

FIGS. 5 A through 5 D are sketches of a general embodiment of a special free moisture removal system with the components and features shown from generally a top and side view.

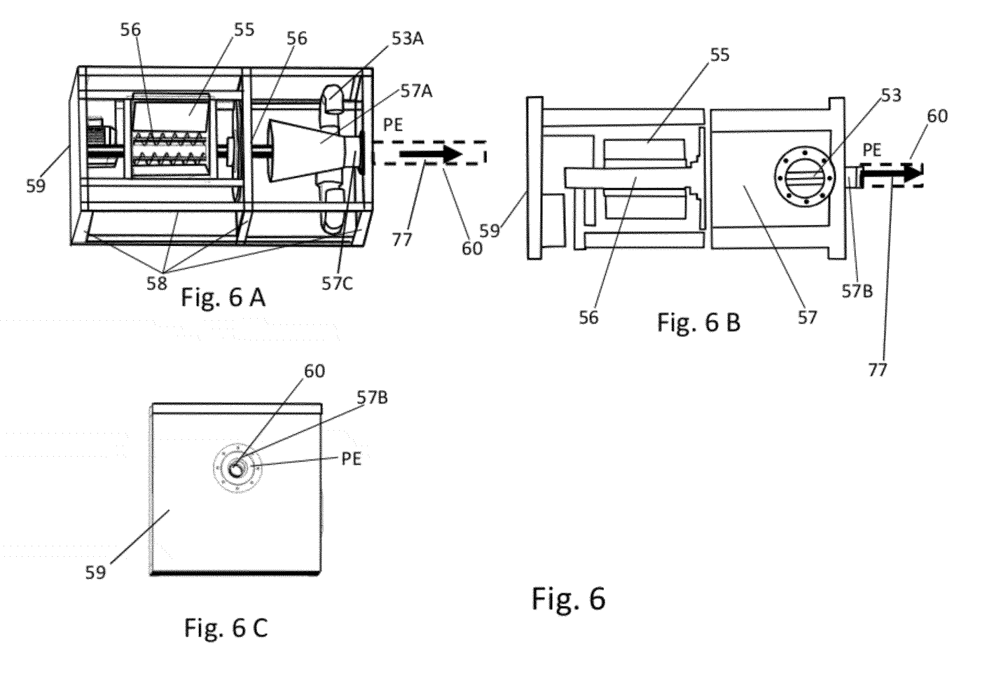

FIGS. 6A through 6 C show the general embodiment of a special free moisture removal system with the components and features shown from Top, Bottom and End views.

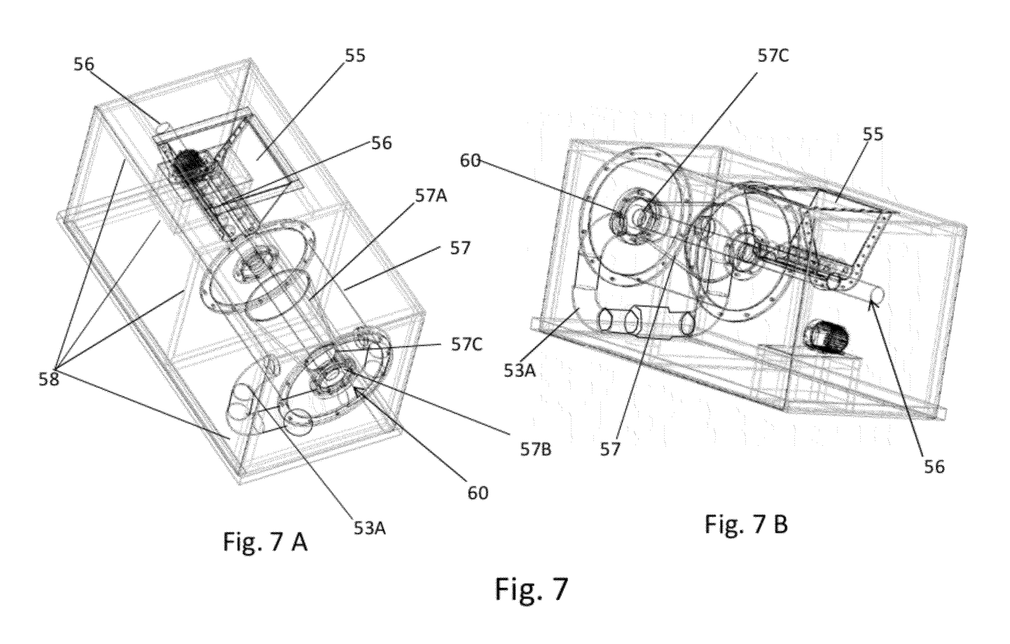

FIGS. 7 A and 7 B show the general embodiment of a special free moisture removal system with the components and features shown in Three Dimensional wire frame views from the input and output ends of the drying system enclosure (with the panels removed).

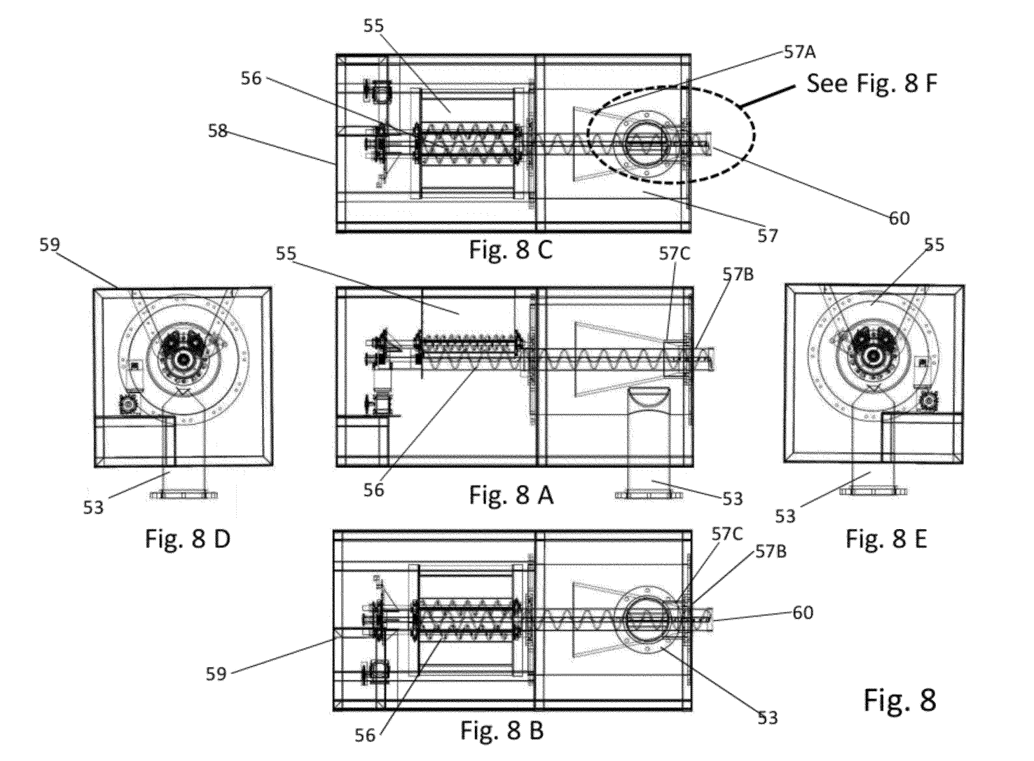

FIGS. 8 A through 8 F show all the views of the preferred dryer system.

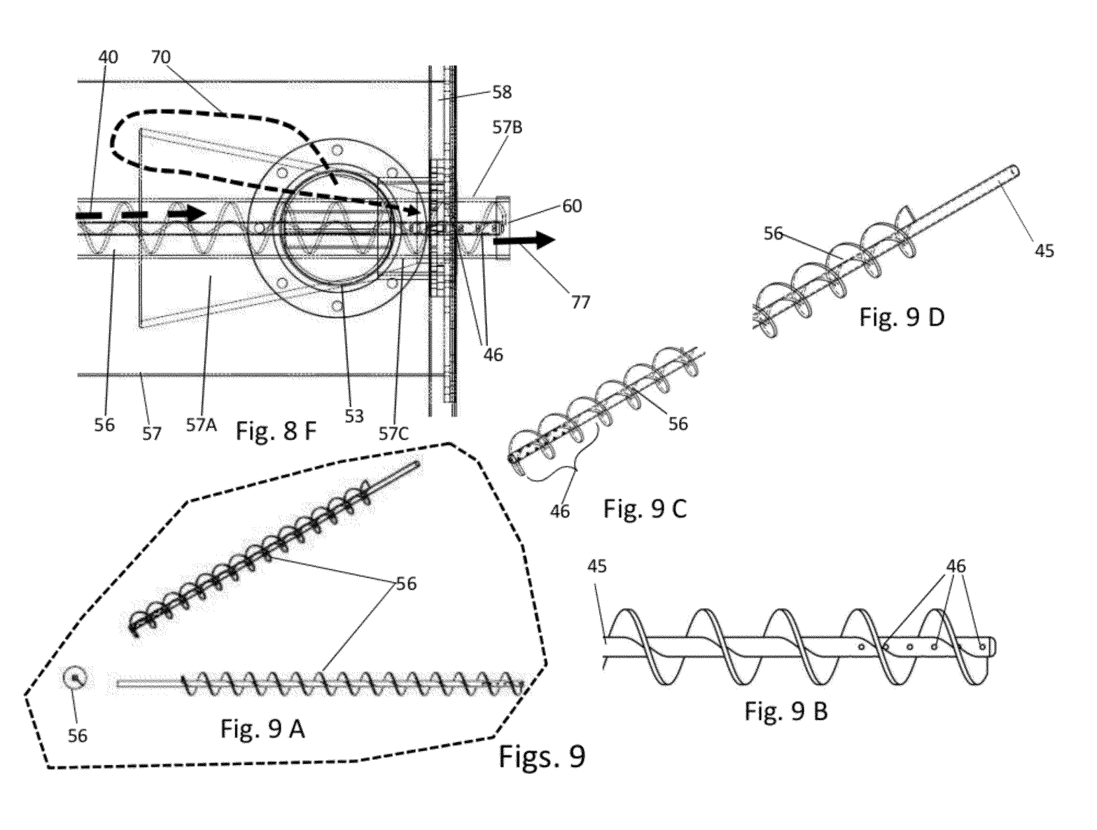

FIGS. 9 A through 9 D show the various means for conveying the material.

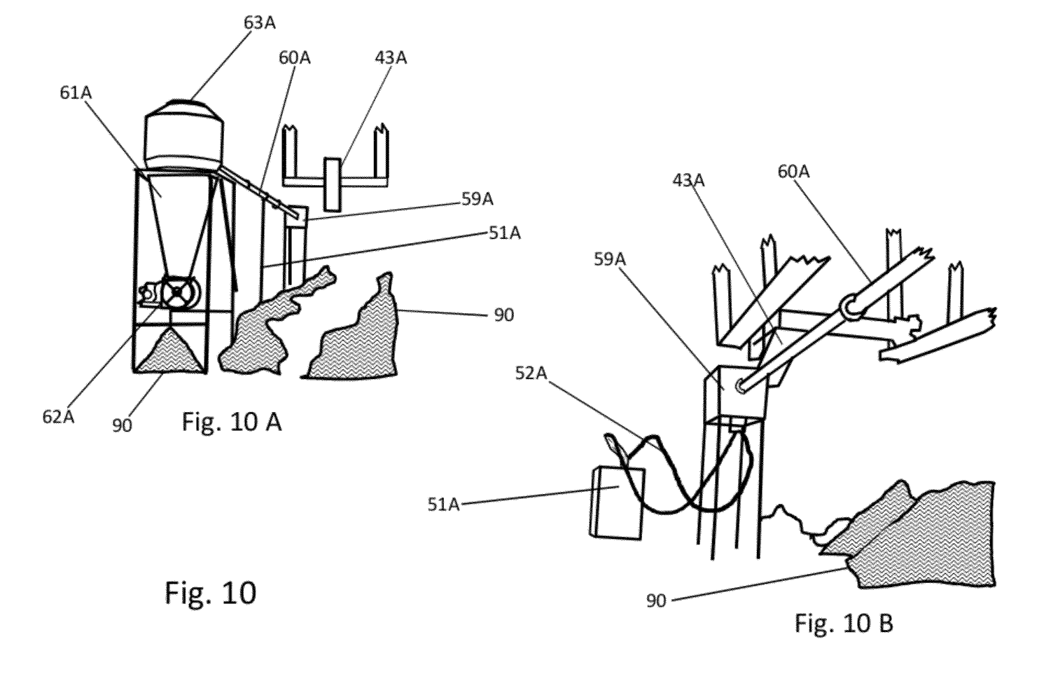

FIGS. 10 A and 10 B are sketches from photographs that are depictions of a prototype of one embodiment of the special free moisture removal system with the components and features shown.

FIGS. 10 A through 10 C are sketches from photographs that are depictions of components of a prototype of one embodiment of the special free moisture removal system.

### DESCRIPTION OF THE DRAWINGS

### Reference Numerals

The following list are components of the special non-thermal drying system. The reference numbers refer to the general drawings in FIG. 1 through FIG. 11.

| Ref # | Description |
|---|---|
| 31 | General embodiment of a special free moisture removal system |
| 40 | Material to be processes - see various listed types |
| 41 | Material collection hopper - if needed |
| 43 | Material conveyance to processor |
| 44 | Aerated apertures (slots) in the auger shaft |
| 45 | Hollow shaft |
| 51 | High volume, low pressure air source such as a blower or the |
| | like |
| 52 | means for conveying the air supplied by the air source into |
| | the drying system |
| 53 | means for conveying the air within the drying system enclosure |
| | either a single or multiple pipes (wyes)53A. Single pipe |
| | having an optional angle diverter to assist in directing air |
| | flow |
| 54 | Optional External Feed Hopper |
| 55 | Internal Feed Hopper |
| 56 | Means for conveying material into the mixing chamber(like an |
| | auger or the like) |
| 56A | Transition from means 56 to mixing chamber 57 |
| 57 | Initial Mixing chamber containing the means 57A |
| 57A | Means for increasing the speed of the air as it enters the |
| | transport piping or tubing of the system(such as a tapered |
| | transition/truncated hollow cone/frustrum or the like) |
| 57B | (Virtual Vacuum) Breaker mechanism - zone where material 40 |
| | and high speed process air 70 combines and the free moisture |
| | 85 flashes out due to the pressure changes and the material, |
| | air and moisture continue into the tube 60 as a combination 77 |
| 57C | Air Pipe transition from acceleration and mixing chamber 57A |
| | to Breaker mechanism 57B |
| 58 | Machine frame for aligning and stabilizing components named |
| | herein this specification of the dryer |
| 59 | Drying system enclosure/sheet of metal, composite materials, |
| | plastic or the like |
| 60 | Transport Tube or Pipe |
| 61 | Means of separating dried solids from moisture-laden air |
| | stream |
| 62 | Means of discharging dried solids from the system |
| 63 | Means of discharging moisture laden air and fine solids |
| 70 | Introduced process air |
| 75 | Moisture-laden air |
| 77 | Combination process air, free moisture and essentially |
| | granulized material |
| 80 | Return air - scrubbed and clean (and essentially dry) |
| 85 | Free moisture/water or a mixture with water as its most |
| | prevalent component |
| 90 | Material that has been processed and the free moisture removed |
| | or significantly reduced from the material |
| PE | Proximal End of tube-like structure 60 |
| DE | Distal End of tube-like structure 60 |
| V | Velocity (speed) of the air [may be effected by the area and |
| | volume per Bernoulli's principles. |

In addition to the above list, the following list shows reference numbers to the prototypes depicted in FIG. 8 and FIG. 9 drawings:

| | Description |
|---|---|
| Ref # | Prototype system |
| 43a | Material conveyance to processor |
| 51a | High volume, low pressure air source such as a blower or the |
| | like |
| 52a | means of conveying the air supplied by the air source into the |
| | drying system |
| 53a | means of conveying the air within the drying system enclosure |
| 54a | Optional External Feed Hopper |
| 55a | Internal Feed Hopper |
| 56a | Means of material conveyance into the drying system |
| 57a | Means of increasing the speed of the air as it enters the |
| | transport piping or tubing of the system |
| 58a | Aligning and stabilizing machine frame |
| 59a | Drying system enclosure |
| 60a | Transport Tube or Pipe |
| 61a | Means of separating dried solids from moisture-laden air |
| | stream |
| 62a | Means of discharging dried solids from the system |
| 63a | Means of discharging moisture laden air and fine solids |

### DETAILED DESCRIPTION OF PREFERRED EMBODIMENT

The present new system embodied here is a special system to remove free moisture from essentially granular materials. The system and related technology allow for the energy efficient separation and removal of free moisture from granular materials including both organic and inorganic materials. The system creates differential pressures in adjacent moving flows. Such pressure differentials induced flash vaporization of free moisture from granular materials, simultaneously with the separation and segregation of water vapor into a moving flow of adjacent air, supported by a novel design that allows for and retains laminar/plug flow characteristics.

The system is sometimes called the Enviro-Dry Tornado Drying System™ or Eco Flash™. The non-thermal drying system for dewatered waste solids is a revolutionary advance in the drying of granular materials and providing dramatic energy savings and a significantly smaller carbon footprint compared to other thermal drying technologies. The special system principally removes free moisture from an essentially granular material and is comprised of readily available components and parts configured in an unique combination.

The advantages for the special system are to remove free moisture from essentially granular materials allows for enhanced net energy produced through subsequent oxidation and allow for: (a) rapid mechanical removal of free moisture (water) within the transport pipe through pressure-induced flash vaporization; (b) physical separation and segragation of water vapor in the “gas” boundary; (c) granular material segregation by mass within the transport pipe; (d) separation of dry solids and moist air via cyclone at the end of the system; (e) the creation of nearly laminar flow conditions via the air-driven system; and (e) extensive drying using multi-stage systems.

The preferred embodiment of the special system to remove free moisture from essentially granular materials is comprised of various readily available components produced in in different configurations and made of various durable materials. Simply stated, the special system is:
“A special drying system made of durable materials, said to remove free moisture from an essentially granular material, (the material consisting of an essentially granular form of solid material mixed with moisture and air) the removal system comprised of
   1. A Feed Hopper for the material;
   2. A means for conveying a material from the feed hopper into the drying system;
   3. A machine frame for aligning and stabilizing a set of components for the dryer;
   4. A drying machine enclosure over the machine frame;
   5. A means for conveying the material into the drying chamber;
   6. An air source that provides and introduces process air;
   7. A transfer means for conveying the process air from the air source into the drying machine enclosure;
   8. A Means for conveying the process air from the transfer means to a mixing chamber all within the drying system enclosure;
   9. A mixing chamber;
   10. A means of increasing the velocity (speed) of the process air as it enters and introduces the process air into the material transport piping of the dryer system, said introduction of the process air combining with the material and resulting a combination of a free moisture, material, and the process air wherein the combination travels at a higher velocity;
   11. A breaker mechanism;
   12. A transport pipe that conveys the combination of the material, the free moisture and the higher velocity air;
   13. A means for separating dried solids from moisture-laden air stream;
   14. A means for discharging dried solids from the system;
   15. A means for discharging moisture laden air and fine solids into free moisture and essentially dry air.”

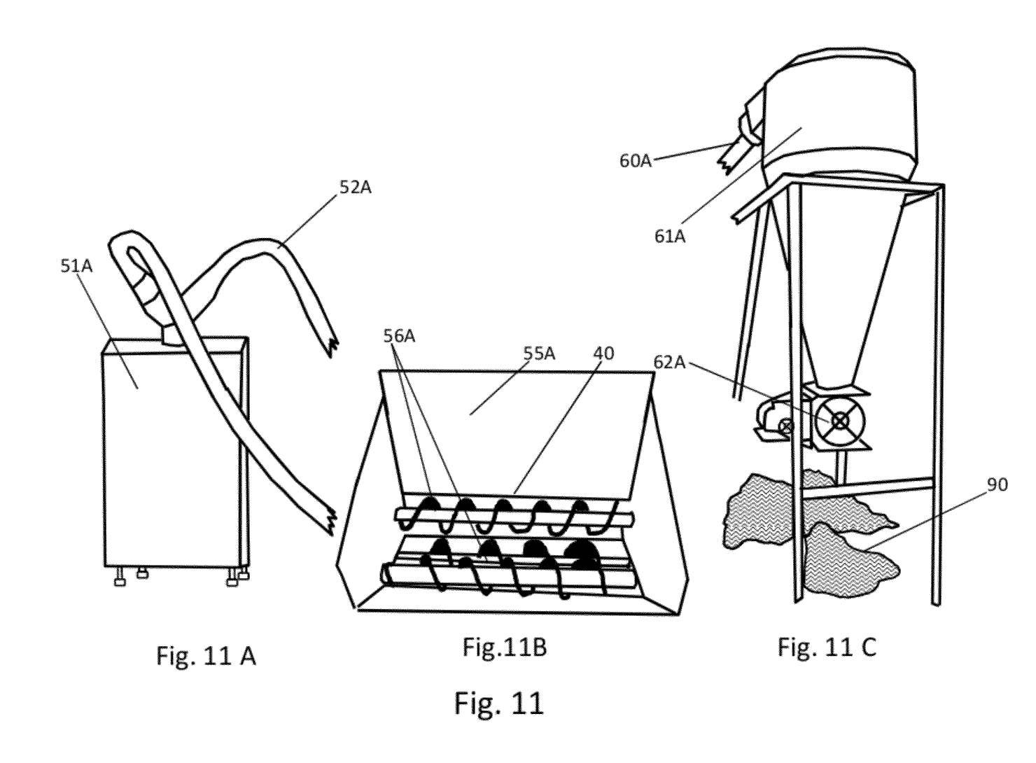

There are shown in FIGS. 1-11 a complete description and operative embodiment of the special system to remove free moisture from essentially granular materials. In the drawings and illustrations, one notes well that the FIGS. 1-9 demonstrate the general configuration of this system. The various example uses are shown in FIGS. 10 and 11 and are thoroughly discussed in the operation and use section, below.

The accompanying drawings, which are incorporated in and constitute a part of this specification, illustrate a preferred embodiment of the special system to remove free moisture from a volume of essentially granular materials. The drawings together with the summary description given above and a detailed description given below serve to explain the principles of the special non-thermal drying system. It is understood, however, that the Special dewatering system is not limited to only the precise arrangements and instrumentalities shown. Other examples of systems that may remove free moisture from granular materials are still understood by one skilled in the art of dewatering devices and systems to be anticipated within the scope and spirit of the system shown here.

FIG. 1 is a sketch of the general embodiment of a special free moisture removal system 31. Shown is the system 31 and part of the materials 40, 90 and expelled air 80.

FIG. 2 is a sketch of the general embodiment of a special free moisture removal system 31 with components and features identified and depicted. The main air source 51 (blower or the like) is show connected to the enclosure 59. The granular material 40 (laden with free moisture 85) is held by a hopper 41 and being conveyed or transferred by a material handling conveyance 43 to the enclosed system 59. In this embodiment, an optional external material hopper 54 is used with the system 31. Also shown is the air source 51 and connection 52 that supplies the process air 70 to the initial mixing chamber 57 and the to the means 57A of increasing the air speed (not shown) connected to the transport tube 60 at the Proximal End PE of the tube 60. There is also an optional breaker mechanism 57B (virtual vacuum breaker) that is the zone where material 40 and high speed process air 70 combines and the free moisture 85 flashes out due to the pressure changes and the material, air and moisture continue into the tube 60 as a combination 77. The moisture and material mixture 77 is conveyed from the breaker 57B, through the tube 60 to the opposite Distal End DE of the tube 60 and connects the tube 60 with the means of separating 61 dried solids 90 from the free moisture 75. As the heavy solids 90 fall out of the means for separating 61 (such as a cyclone or the like) the solids 90 are controlled through a means for discharging 62 the solids 90 from the system 31. This solids material 90 collector means may be like a cyclone, target box or the like. At the same time, the free moisture 75 is collected by the means for discharging 63 the moisture laden air 75 and fine solids. This collection means 63 may be a wet scrubber or the like. Discharged from the collection means 63 are the free moisture (water) 85 and the dry discharged air 80. More description of the components are shown below.

FIG. 3 is an isometric sketch of a general embodiment of a special free moisture removal system 31 with the components and features shown from generally a top and side view. Here the enclosure 59 is shown around the support and stabilizing frame 58. The air source 51 is connected by a connection means 52 from the air source to the internal process air 70 means for conveying 53. This means 53 of conveying supplies the air 70 from the air source 51 and connection 52 to the means of increasing 57A the speed V of the air 70 as it (the air 70) enters the transport tube 60 at the Proximal End PE of the tube 60. Meanwhile the material 40 has been conveyed to the enclosure 59 and deposited into the internal hopper 55. The material 40 then is conveyed by a means 56 (such as an auger or the like—and see alternative augers in FIG. 9, below), through a simple transition 56A, through the means 57A for increasing the speed of the air as it enters the transport piping or tubing of the system (such as a tapered transition/truncated hollow cone/frustrum or the like); then, to connect the cone the materials travel through an air pipe transition 57C from the acceleration and mixing chamber 57A to Breaker mechanism 57B. The air 70 and material 40 begin to mix. The full mixture and pressure differential occurs at the (Virtual Vacuum) Breaker mechanism. In this zone is where material 40 and high speed process air 70 combines and the free moisture 85 flashes out due to the pressure changes and the material, air and moisture continue into the tube 60 as a combination 77. The moisture and material mixture 77 is then conveyed from the Proximal End PE to the Distal End DE of the transport tube 60. (This may be seen in an expanded view in FIG. 2). As a special note, the transition 57C is a means for connecting the breaker 57B and tube 60 (which may be differing diameters—4, 5, 6, 8, etc) to the acceleration chamber 57A which is anticipated as a set, standard diameter. Therefore, the transition 57C may be of various transition ratios (3:1, 2:1, 1:1, etc.). Further details about the components are described below in the other paragraphs.

FIGS. 4 A and 4 B are isometric sketches. FIG. 4 is of a general embodiment of a special free moisture 85 removal system 31 with the components and features shown. The sketches show the enclosure 59 around the support and stabilizing frame 58. The air source 51 is connected by a connection means 52 to the single pipe internal process air 70 conveyance means 53. Empirical data shows the single pipe 53 has helped to reduce the backpressure and maximize the air 70 obtained from the blower (air source) 51. The single pipe 53 that has an open downstream end and across that opening the is an optional divider (like a piece of angle iron with the joined corner pointed down), that serves to direct the incoming air into opposite sides of the air housing 57 and into the chamber 57A. This single pipe means 53 for connecting (which is the preferred embodiment) supplies the air 70 from the air source 51 and connection 52 to the means of increasing 57A the speed V of the air 70 as they (the accelerating air 70 and the material 40) travel through the air pipe transition, begin to mix and reach the breaker 57B. The (Virtual Vacuum) Breaker mechanism 57B is the zone where material 40 and high speed process air 70 combine and the free moisture 85 flashes out due to the pressure changes. The material, air and moisture continue into the tube 60 as a combination 77. One also notes that the material 40 has meanwhile been conveyed to the enclosure 59 and deposited into the internal hopper 55. The material 40 then is conveyed by a means 56 (such as an auger or the like), through a transition 56B, into the increasing means 57A where it intermixes with the air 70 and stars to becomes a mixture 77. The combination 77 continues transport from acceleration and mixing chamber 57A through the air pipe transition 57C to Breaker mechanism 57B and then exits the means 57B and travels to the tube-like transport tube 60 where the process air 70 is continued to move with the material 40 and the free moisture 85 as a combination 77. The moisture and material mixture 77 is then conveyed from the Proximal End PE to the Distal End DE of the transport tube 60. (This may be seen in FIG. 2). While in the tube, the moisture 85 reaches a flash point where it evaporates out and continues through the tube. This explained further, below. FIG. 4 B shows a dual pipe 53A “wye” which is two smaller pipes 53A as the air 70 enters the air housing 57 instead of directing the air 70 directly into the air mixing chamber 57A. One may note that the breaker device 57B anticipates a mechanism as a series of holes into the auger in this zone which may be specifically and empirically determined to best impact the handling and transfer of material of a given density and size.

FIGS. 5 A through 5 D are sketches of a general embodiment of a special free moisture 85 removal system 31 with the components and features shown from generally a top and side view. Especially noted in FIG. 5 B is the movement zone from the acceleration chamber 57A, into the transition 57C and finally at the breaker 57B ahead of the transport pipe 60. The other components shown are the same as described in FIGS. 3 and 4 in the above paragraphs. Note the air conveyance means is the alternative embodiment of a dual pipe 53A in these views.

FIGS. 6 A through 6 C show the general embodiment of a special free moisture 85 removal system 31 with the components and features shown from Top, Bottom and End views. These sketches show the enclosure 59 around the support and stabilizing frame 58. The air source 51 (not shown here) is connected by a means 52 for connecting to the internal process air 70 single pipe means 53 for conveying FIG. 6B and the dual pipes 53A in FIG. 6A. These means 53/53A supply the air 70 from the air source 51 and connection 52 to the means of increasing 57A the speed V of the air 70 as it (the air 70) travels through the transition 57C, continues to mix with the material 40, travels into the breaker 57B and then enters the transport tube 60 at the Proximal End PE of the tube 60. Meanwhile the material 40 has been conveyed to the enclosure 59 and deposited into the internal hopper 55. Once again one sees the material 40 is conveyed by a means 56 (such as an auger or the like) through the transition 56A, through the accelerating chamber 57A, through the transition 57C, through the breaker 57B and next into the tube-like transport tube 60 where the combination 77 continues down the tube 60. The moisture and material combination 77 is then conveyed from the Proximal End PE to the Distal End DE of the transport tube 60. (This may be seen in FIG. 2).

FIGS. 7 A and 7 B show the general embodiment of a special free moisture 85 removal system 31 with the components and features shown in Three Dimensional wire frame views from the input and output ends of the drying system enclosure 59 (with the panels removed from the machine frame 58). All the noted components have been described in FIGS. 3, 4, 5 and 6. One notes well the ability here to see the internal configurations behind the enclosure panels 59.

FIGS. 8 A through 8 F show all the views of the preferred dryer system 31. All the components that are shown here have been described in the above figures. One notes well the expanded view in FIG. 8 F that describes the material 40 and air 70 mixing, flashing (with the pressure differential) to release the free moisture 85 and continuing through the tube 60 as a combination 77 to the mechanisms for final separation into dry material 90, moisture/liquid 85, and dry air 80.

FIGS. 9 A through 9 D show the various means for conveying 56 (such as an auger or the like) the material 40. FIG. 9 A shows the top, end and isometric vies of the entire Means 56 for conveying material into the mixing chamber 57A (like an auger or the like). FIG. 9 D shows the material loading end with a hollow shaft 45. FIG. 9 C shows the opposite end where the optional breaker 57B meets the transfer pipe 60. Here the auger has slots or apertures to help break-up the vacuum and assist the materials 40 to flash the fluid to a state of free moisture 85 in the combination 77. FIG. 9 D shows an exploded view of the apertures 46 and the hollow shaft 45 in the means 56 for conveying material into the mixing chamber (like an auger or the like). As an alternative embodiment, different material handling mechanisms 56 may be substituted for the auger and still be within the scope and spirit presented with this dryer system.

All the FIG. 1 through FIG. 9 are sketches of the embodiment of the special system 31 to remove free moisture 85 from a volume of essentially granular materials 40. A more in depth discussion of the components, alternative components and features of the preferred and alternative components follows here. One skilled in the art of such dewatering systems realizes the many different combinations of these components are possible and are fully anticipated by the scope and spirit of the dewatering of free moisture system presented here, Likewise, various potential durable materials with which to manufacture the components are discussed as examples and not as limitations to the preferred embodiment of the special system 31.

The technology allows for the energy efficient separation and removal of free moisture 85 from granular materials 40 including both organic and inorganic materials. The system 31 creates differential pressures in adjacent moving flows. Such pressure differentials result in the pressure-induced flash vaporization of free moisture 85 from granular materials 40 and into a moving flow of adjacent process air 70.

The system is comprised essentially of fifteen (15) or less components. One skilled in the art of similar air and material conveyance systems may combine some of these components and still be well within the scope and spirit of the full non-thermal drying system portrayed herein. One of the primary components is a high volume, low pressure air source 51 such as a Blower. Alternative blower types may include for example but not as a limitation a turbine style blower system; a positive displacement (Roots style) blowers; centrifugal fans; axial fans; screw/auger conveyor type blower; and hybrid blowers utilizing combinations of the above technologies;

Along with the air source 51 is a Means 52 for conveying the air supplied by the air source into the drying system. Alternative conveyance types may include for example but not as a limitation conveyance be via steel, rubber pipe, plastic or other synthetic tubing or hose; conveyance equipped with an expansion joint to isolate vibration; and conveyance equipped with a check valve. Next is a further Means 53 for conveying the air within the drying system enclosure. Alternative types may include for example but not as a limitation air entering the system is directed into a housing; housing can be cylindrical, spherical, rectangular or of any other shape; and air can enter the housing via s single or multiple entry ports; or the like.

An Optional External Feed Hopper 54 may be included as part of the overall special dewatering system 31 to remove free moisture 85. Alternative types may include, for example but not as a limitation, an optional means of directing the material to be dried into the internal hopper or alternate feed component of the drying system; Optional for materials subject to clumping and/or bridging, a means of breaking up clumps and disrupting bridging in the material to facilitate the smooth feeding of materials into the internal feed hopper or alternate feed component of the drying system; Optional external feed hopper can be constructed of steel, fiberglass, rubber, plastic or other synthetic materials; or the like. A next component comprising the system 31 is an Internal Feed Hopper 55. Alternative types may include for example but not as a limitation a means of organizing and directing material to be dried into the transport piping or tubing of the system; Internal feed hopper provides entry into the drying system and may, or may not, be equipped with a mechanical means for conveying material into the drying system; or the like.

For the material 40 to be introduced to the special system 31 to remove free moisture 85 there is a Means for providing 56 a material conveyance into the drying system. Depending on the nature and characteristics of the material to be dried a means of material conveyance into the drying system may be included. Such a conveyance system will include a material feed tube or equivalent component of the means of conveyance. Alternative means may include for example but not as a limitation a screw auger or series of screw augers—these augers can be standard solid shafted, hollow-shafted, un-shafted, flexible or inflexible augers, or any other style of auger conveyor; alternately the conveyance may use vacuum generated by air flow through the system to pull material into the transport piping or tubing of the system without any additional mechanical means. If vacuum feeding is used, a means of restricting air flow into the material feed system must be employed. This restriction means could include a rotary airlock or similar means of restricting air flow.

A very key component of the special dewatering system 31 to remove free moisture 85 is a Means of increasing 57 the speed (velocity) of the air as it enters the transport piping 60 or tubing of the system 31. This means of increasing may be comprised as:
a. A funnel or cone is mounted within the housing, with the mouth of the funnel remaining open and unobstructed, except by the material feed tube;
b. The material feed tube enters the housing through a sealed port and extends through the housing, inside the center of the funnel;
c. Said material feed tube, extends from the internal feed hopper and extends to the end of the dryer unit;
d. Said material feed tube may include an auger or alternate means of conveyance to move material toward the end of the material feed tube;
e. Air travels into the housing and into the mouth of the funnel;
f. Air 70 travels down the length of the interior of the funnel, constrained by the exterior of the feed tube 60 and the interior walls of the funnel or cone;
g. As air travels toward the small end of the funnel, or cone the volume reduction results in an increase in the airflow velocity V, consistent with the degree of volume reduction in the flow path;
h. Consistent with the Bernoulli principle, the increased air flow velocity V produces a marked reduction in pressure;
i. Air exits the funnel or cone between the interior wall of the foot of the funnel and the exterior wall of the feed tube 60;
j. This rapidly moving air forms a relatively stable boundary air layer on the inside wall of the transport pipe and maintains this configuration over the entire length of the transport tube or pipe; and
k. Material feed tube 56 containing the screw auger or other means of conveyance, extends to the end of the funnel or beyond.

Another structural component of the Drying system 31 components 53 through 57 above, excluding optional component 54 above may be a machine frame 58 mounted within that serves to align and stabilize the components of the non-thermal drying system in the proper orientation for operation. This frame 58 can be constructed of steel, composite materials, structural plastics or any other material of sufficient strength and stiffness. The frame 58 and several of these aligned components are surrounded and contained by a Drying system enclosure 59. The frame 58 upon which the drying system components 53, 55, 56, and 57 are mounted can encased by a skin of sheet steel, other metal or plastic with ventilation provided, as needed.

The manner the essentially granular material 40 exits the containing frame 58 and encasement 59 through the interior of a Transport Tube or Pipe 60. This tubular like component 60 has a proximal end PE and a distal end DE and consists of metal (steel, aluminum, steel alloy or other durable material), plastic (reinforced or composite), rubber or another synthetic composite (or the like) tubing or piping. The tubular like component 60 extends from the proximal end PE at the dryer feed unit (components 53 through 59, excluding 54) to the distal end DE at a means of separating 61 dried solids 90 from moisture-laden air stream 75. The preferred alternative of the tubular like component 60 is an essentially straight run of pipe from approximately twenty (20) linear feet to one or more hundreds ('00s) of feet in length. The diameter of the transport tubing 60 or piping is based on the material 40 and air 70 flows. The tube-like structural member 60 can range from around two inches (2″) in diameter to approximately twenty-four inches (24″) or larger.

The Means for separating 61 dried solids 90 from moisture-laden air stream 75 depending on the nature and characteristics of the combined material, air and moisture mixture 77 to be dried can be separated through several types of components or subsystems such as: (a). a cyclone separator; (b). a target box; (c). an air classifier; (d). filter receiver; or (e). other means of air solids separation.

Means for discharging 62 dried solids 90 from the system depends on the type of separator 61. The means of controlling the discharge can include a rotary airlock and/or a gravity drop or slide. Finally, a means for discharging 63 moisture laden air 75 and fine solids as dry air 80 and free moisture 85, if present, may include a simple wet scrubber; a direct discharge; and/or a bag house.

The details mentioned here are exemplary and not limiting. Other specific components and manners specific to describing a preferred embodiment of the special system to remove free moisture from a volume of essentially granular materials may be added as a person having ordinary skill in the field of dewatering and free moisture removal systems, devices and their uses well appreciates.

### OPERATION OF THE PREFERRED EMBODIMENT

The preferred embodiment of the special system 31 to remove free moisture 85 from a volume of essentially granular materials 40 has been described in the above paragraphs. The manner of how the device operates is described below. One skilled in the art of de-watering materials and the related systems and devices notes well that the description above and the operation described here must be taken together to fully illustrate the concept of the preferred embodiment of the special system to remove free moisture from a volume of essentially granular materials. Shown in FIG. 2 is the Enviro-Dry Non-Thermal Drying System. A special system 31 to remove free moisture 85 from a material (the material consisting of an essentially granular form 40, 90 of solid material mixed with moisture and air) the removal system comprised of: A Feed Hopper 55 for the material 40; a means 56 for conveying a material 40 from the feed hopper 55 into the drying system 31; a machine frame 58 for aligning and stabilizing a set of components [see reference table above] for the dryer system 31; an enclosure 59 over the machine frame 58; a means 56 for conveying the material into the drying chamber 57; an air source 51 that provides and introduces process air 70; a transfer means 52 for conveying the process air 70 from the air source 51 into drying system enclosure 59; a Means for conveying the process air 70 from the transfer means 52 to a mixing chamber 57 all within the drying system enclosure 59; a mixing chamber 57; a means 57A of increasing the velocity (speed) of the process air 70 as it enters and introduces the process air 70 into the material transport piping of the dryer system, said introduction of the process air 70 combining with the material 40 and resulting a combination 77 of a free moisture 85, material 40, and the process air 70 wherein the combination travels at a higher velocity V; a virtual vacuum breaker mechanism 57B and a means for introducing the combination 77 at the Proximal End PE of a transport pipe 60; the transport pipe 60 that conveys the combination 77 of the material 40, the free moisture 85 and the higher velocity air 70; a means 61 for separating dried solids 90 from combination 77 with the moisture-laden air stream 75; a means 62 for discharging dried solids 90 from the system 31; means 63 for discharging moisture laden air 75 and a quantity of fine solids into free moisture 85 and essentially dry air 80.

The technology allows for the energy efficient separation and removal of free moisture 85 from granular materials 40 including both organic and inorganic materials. The system 31 creates differential pressures in adjacent moving flows. Such pressure differentials result in the induced flash vaporization and separation of free moisture 85 from granular materials 40 and into a moving flow of adjacent process air 70.

Many applications, uses and materials to remove free moisture are anticipated for the special system 31 to remove free moisture 85 from a volume of essentially granular materials 40. Some examples anticipated are listed to demonstrate potential uses. This listing is exemplary and not limitations to the system 31. For example, the drying system 31 can be applied for highly energy efficient free moisture removal from a wide variety of materials 40, including, but not limited to:

| Ref 1 | Ref 2 | Description |
|---|---|---|
| 1 | | Aggregates |
| | A | Sand |
| | B | Gravel |
| | C | Ground Stone |
| | D | Cement |
| 2 | | Coal |
| | E | Crushed coal |
| | F | Waste coal |
| | G | Coal slurries |
| 3 | | Recycled Materials |
| | H | Ground Rubber |
| | I | Ground Plastic |
| | J | Ground Glass |
| | K | Ground Asphalt Shingles |
| 4 | | Agricultural Wastes and Products |
| | L | Dewatered dairy manure - raw and post-digester wastes |
| | M | Dewatered swine manure- raw and post-digester wastes |
| | N | Chicken litter |
| | O | Used bedding sand |
| 5 | | Municipal Waste Treatment |
| | P | Dewatered municipal biosolids - if Electro-coagulated |
| | | rather than polymer treated |
| 6 | | Distiller's Grain |
| | Q | Distiller's grain from ethanol fuel plants |
| | R | Distiller's grain from breweries and distilleries |
| 7 | | Food and Food Processing |
| | S | Corn starches - pearl and modified |
| | T | Corn syrup solids (may be difficult) |
| | U | Corn gluten meal |
| | V | Wheat starch |
| | W | Whey and whey protein |
| | X | Soy meal |
| 8 | | Food Processing By-Products |
| | Y | Dewatered food processing wastes |
| 9 | | Potential Industry Partners |
| | Z | Paper Pulp-if Electro-coagulated rather than polymer |
| | | treated |
| | AA | Crushed Glass |
| | BB | Sawdust |
| | CC | Gypsum and Calcium sulfite (flue gas de-sulfurization |
| | | by-products |
| | DD | Lime |
| | EE | Chalk |
| | FF | Lead Oxide |
| | GG | Many other industrial products, wastes and byproducts |

FIGS. 10 A and 10 B are depictions of a prototype 31A of one embodiment of the special free moisture removal system 31 with the components and features shown. Here the air source 51A is connected by the means to convey 52A the process air 70 to the enclosure 59A. Moisture laden material 40 is transferred to the system 31 by the conveyor means 43A. The material 40 is mixed with process air 70 at the means to increase 57 air speed V [means 57 not shown]. From the dryer enclosure 59A, the transport tube 60A conveys the mixture 77 from the enclosure 59A to the means to separate 61A solids 90. The means to discharge 62A the solids 90 and the means to remove 63A the moisture 85 from the dry air 80 completes the components in the prototype 31A of the free moisture removal system 31.

FIGS. 11A through 11 C are depictions of components of a prototype 31A of one embodiment of the special free moisture 85 removal system 31. Here the air source 51A and the means to convey 52A process air 70 are shown in FIG. 9 A. The internal hopper 55A with the auger/material conveying means 56A and some material 40 is depicted in FIG. 9B. Finally, in FIG. 9 C, the transport tube 60A, the material separation means 61A, the means 62A to separate moisture laden air 75 from the essentially dry material 90 are depicted.

An effective way to demonstrate the use and operation of this prototype system is to provide the empirical data and results. A summary of an Example operation and the results achieved are very encouraging. An EnviroSolve BioEnergy proprietary technology treatment system 31A combined an integrated waste management and energy recovery system to large dairies and other high-concentration animal feeding operations (CAFOs). This represented a closed-loop, renewable energy facility based on the combustion of dewatered and dried animal wastes. This prototype of EnviroSolve's technology platform utilized existing, proven technologies applied in a customized, proprietary treatment system. This treatment “train” of components provided a system to convert the animal wastes into a viable and economical bio-mass fuel source. The summary of key performance features of the technology platform included:
Greater than 99.7% solids capture;
Greater than 80% nutrient recovery;
Nutrient recovery in usable and customizable forms;
Energy recovery through combustion, gasification, or pyrolysis of dewatered bio-solids; and,
“Clean” gray water for reuse in waste flushing operations, irrigation, or direct discharge

Effective results of the Special Free Moisture Removal System 31 are more likely to be achieved when a system 31 is properly matched with conditions of the materials to be processed. Appropriate operating parameters for most A Special Free Moisture Removal Systems 31 are shown as:

| Item | Operating Parameters |
|---|---|
| 1 | Process any granular material - wet or dry - from 2 |
| | microns up to 25 millimeters |
| 2 | Systems processing capacities to >100 TPH |
| 3 | Systems operate at low air pressure 4 PSI to 15 PSI |
| 4 | Transport distances up to 1,500 feet including |
| | horizontal and vertical runs with sweeps |

Flexibility when setting-up and customizing the system 31 for the specific material parameters are shown as:

| Item | Process Flexibility |
|---|---|
| 1 | Totally enclosed low pressure systems eliminate |
| | environmental exposures |
| 2 | Minimal product degradation |
| 3 | Fully-automated systems with continuous or |
| | interrupted feed |
| 4 | Systems will accommodate the use of blending gases |
| | or fluids |
| 5 | Product can be cooled or heated with transport air |
| 6 | Transport lines can run above or below ground or be |
| | supported by existing infrastructure |
| 7 | Transport lines can operate at any angle; and |
| 8 | Compact system size with easy installation, |
| | minimizing downtime and installation cost. |

The description of the steps in the Operation for Special Free Moisture Removal System 31 are shown as:

| Item | Operational Description |
|---|---|
| 1 | Air supplied by the air source is conveyed through |
| | the conveyance described in 2a above; |
| 2 | Air enters the housing (3 a-d) and travels into the |
| | mouth of funnel. |
| 3 | Air travels down the length of the interior of the |
| | funnel, constrained by the exterior of the feed tube |
| | and the interior walls of the funnel; |
| 4 | As air travels toward the small end of the funnel, |
| | it speeds up and its internal pressure drops; |
| 5 | Air exits the funnel between the interior wall of |
| | the small end of the funnel and the exterior wall of |
| | the feed tube; |
| 6 | This rapidly moving air forms a relatively stable |
| | boundary air layer on the inside wall of the |
| | transport pipe and maintains this configuration over |
| | the entire length of the transport tube or pipe; |
| 7 | This rapid air flow also creates a strong vacuum at |
| | the end of the material feed tube, pulling the |
| | material to be dried into the center of the |
| | transport tubing; |
| 8 | As solids move relatively slowly through the middle |
| | of the pipe, adjacent air in the boundary layer is |
| | moving rapidly and is at correspondingly lower |
| | pressure; |
| 9 | Under the influence of this pressure differential, |
| | free moisture vaporizes and is simultaneously drawn |
| | from the solids and into the boundary layer; |
| 10 | Some of this moisture draws waste heat, produced by |
| | the friction of air moving along the tube walls, |
| | further supporting the phase change from liquid |
| | water to water vapor; |
| 11 | As the boundary layer and dried solids enter the |
| | separator at the downstream end of the transport |
| | tube, the dried solids and moisture-laden air are |
| | separated; |
| 12 | If a cyclone separator is used, for example, |
| | moisture-laden boundary layer air will discharge |
| | through the top of the cyclone, while the dried |
| | solids will discharge from the bottom of the |
| | cyclone, usually with the discharge controlled by a |
| | rotary airlock; |
| 13 | The moisture-laden boundary layer air can be |
| | directed to simple wet scrubber or to the |
| | atmosphere, depending on the nature and |
| | characteristics of the material being dried; |
| 14 | Depending on the material being dried, the moisture |
| | content of the material and air flow/material flow |
| | ratio, a single pass through the system will reduce |
| | the moisture of the dried material by 10 to 20 |
| | points, or more[This means, for example, that for |
| | high moisture organics, such as dewatered dairy |
| | manure the system can achieve moisture reductions of |
| | 10 to 20 points in a single pass. For example, the |
| | dewatered manure is typically 74% to 81% moisture by |
| | weight. After one pass the results show that the |
| | system can reduce that moisture content from 81% to |
| | as low as 61% or from 74% to as low as 54%. For |
| | distiller's grain, the system can achieve similar |
| | reductions. This distiller's grain material |
| | typically starts at 60% to 65% moisture.]; |
| 15 | For more extensive drying, the solids discharge from |
| | the first stage drying system can feed directly into |
| | the external hopper of a second stage drying system |
| | and so forth with four or five stage systems being |
| | economically viable for some drying processes; |

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

Unless defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described above in the foregoing paragraphs.

Other embodiments of the invention are possible. Although the description above contains much specificity, these should not be construed as limiting the scope of the invention, but as merely providing illustrations of some of the presently preferred embodiments of this invention. It is also contemplated that various combinations or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope. Accordingly, the subject matter recited in the claims is not coextensive with and should not be interpreted to be coextensive with any particular embodiment, feature, or combination of features shown herein. This is true even if only a single embodiment of the particular feature or combination of features is illustrated and described herein. Thus, the appended claims should be read to be given their broadest interpretation in view of the prior art and the ordinary meaning of the claim terms.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques.

With this description it is to be understood that the preferred and alternative embodiments, applications and uses of the special system 31 to remove free moisture from a volume of essentially granular materials 40 is not to be limited to only the disclosed embodiment of the dewatering system. The features of the preferred embodiment of the special system 31 to remove free moisture from a volume of essentially granular materials are intended to cover various modifications and equivalent arrangements included within the spirit and scope of the detailed description and operation of the system presented in the above paragraphs and the accompanying drawings.

What is claimed is:

1. A special dewatering and free moisture removal system made of durable materials, said system to remove free moisture from a material, the material consisting of an essentially granular form of solids mixed with moisture and air, the said system comprised of:
a) A Feed Hopper for the material;
b) A means for conveying a material from the feed hopper into the drying system;
c) A machine frame for aligning and stabilizing a set of components for the dryer;
d) A drying machine enclosure over the machine frame;
e) A means for conveying the material into the drying chamber;
f) An air source that provides and introduces process air;
g) A transfer means for conveying the process air from the air source into the drying machine enclosure;
h) A means for conveying the process air from the transfer means to a mixing chamber all within the drying system enclosure;
i) A mixing chamber;
j) A means of increasing the velocity (speed) of the process air as it enters and introduces the process air into the material transport piping of the dryer system, said introduction of the process air combining with the material and resulting a combination of a free moisture, material, and the process air wherein the combination travels at a higher velocity;
k) A breaker mechanism;
l) A transport pipe that conveys the combination of the material, the free moisture and the higher velocity air;
m) A means for separating dried solids from moisture-laden air stream;
n) A means for discharging dried solids from the system;
o) A means for discharging moisture laden air and fine solids into free moisture and essentially dry air.”
wherein the non-thermal system creates differential pressures in adjacent moving flows and such pressure differentials result in the induced flash vaporization of free moisture that results in efficiently removing free moisture from essentially granulized materials.

2. The device according to claim 1 wherein the durable materials are metal.

3. The device according to claim 1 wherein the durable materials are a composite material.

4. The device according to claim 3 wherein the composite material is a reinforced, structural plastic.

5. The device according to claim 1 wherein the means for conveying the material into the drying chamber is an auger.

6. The device according to claim 5 wherein the auger has a series of perforations and a hollow shaft.

7. The device according to claim 1 wherein the means for conveying the process air within the enclosure is a single pipe with a dividing angle.

8. The device according to claim 1 wherein the means for conveying the process air within the enclosure is a multiple pipe configuration.

9. The device according to claim 1 wherein the breaker mechanism is a series of holes calculated to impact the material of a given density.

10. The device according to claim 1 wherein the means to increase the velocity of the air is a tapered transition pipe.

11. The device according to claim 1 wherein the means for separating dried solids from moisture-laden air stream is a cyclone.
